(19) United States
(12) Patent Application Publication
(10) Pub. No.: US 2024/0411112 A1
(43) Pub. Date: Dec. 12, 2024

(54) Smart Phone with Light Resonators

(71) Applicant: Metaone Corporation, Taipei City (TW)

(72) Inventors: Kuo-Ching CHIANG, New Taipei City (TW); Yueh-Feng CHIANG, Taipei City (TW)

(21) Appl. No.: 18/737,714

(22) Filed: Jun. 7, 2024

(30) Foreign Application Priority Data
Jun. 7, 2023 (TW) 112121530
Jul. 14, 2023 (TW) 112126525

(51) Int. Cl. G02B 13/00; G02B 1/04; G03B 30/00

(52) U.S. Cl. CPC G02B 13/0045; G02B 1/041; G02B 13/0055; G02B 13/008; G03B 30/00

(57) ABSTRACT

A smart phone includes a lens set formed in front of an image sensor. An optical lens is configurated in front of the lens set, the image sensor or the combination thereof. The optical lens includes at least one transparent layer having trenches, resonators are formed in the trenches, wherein the resonators are formed with different sizes and responsive to different light frequencies.

### TECHNICAL FIELD

The present invention relates to an optical lens, more specifically, a smart phone having an optical lens with light resonators.

### BACKGROUND

With the advancement of science and technology, electronic products, such as digital cameras, mobile phones, etc. are constantly developing towards thin, light and compact features. Therefore, the optical components or devices of these electronic devices must also be miniaturized to comply with the industrial trend. In order to meet above requirements, the imaging device not only has to improve quality, but also needs to be reduced in size and cost.

The camera module of a smartphone is mainly composed of an image sensor, lenses and a coil motor component. Smartphone lenses are generally made of two materials: plastic and glass. Plastic lenses are currently the main material due to their thinness and low cost. Recently, although image sensor size is reduced and the pixel density is improved, however, there are some factors that affect its performance. As the size of the lens becomes smaller and smaller, its physical limitations will inevitably limit the image sensor performance.

Typically, fixed magnets are configurated around the camera module to generate magnetic fields for interacting with the coil. The lens module is coupled with the coils, thereby moving the lens back and forth for autofocus. When energized, the lens is moved relatively to the image sensor in a direction, the lens and the sensor can move independently.

As multiple lenses smartphone continues to rise, it drives the multi-lens market to grow significantly, prior arts US patents U.S. Pat. No. 7,826,151 and US2010/0254029 respectively employ five lenses. The lenses design towards the trend of shorter length. In terms of lens technology, 7P mobile phone are currently the mainstream. The so-called 7P refers to that the lens set is composed of seven plastic lenses. CN 212515189U discloses lens set with more lenses, which are arranged sequentially from the object side to the image side along the optical axis, thus resulting in a highly complex lens structure. Most smartphone lenses today protrude from the back cover. This is because the current lens set has more than seven lenses, plus a transparent lens protective cover, so it is impossible to reduce the thickness of the lens module.

The traditional structure is complex and too thick, what is required is to solve above issues.

### SUMMARY OF THE INVENTION

The present invention discloses a lens set with light resonators, the lens set includes pluralities of lenses, and resonators disposed in front of the lenses. The light resonator is responsive to certain wavelength of light to covert the medium refractive form positive refractive index to negative or zero refractive index based on resonance. The resonator includes a pillar, a spiral or split ring pattern. The ring shape includes circle, rectangle, triangle, C-shape, S-shape, U-shape or any combination of the above.

The present invention discloses a lens set with light resonators, which includes a straight wire array and/or a split ring array to form a two-dimensional or three-dimensional stacking structure.

The present invention discloses a lens set with light resonators. A protection transparent cover is formed in front of the lens set. The lens set includes pluralities of lens, and resonators are disposed on the inner or the outer surface of the protection cover. The light resonator is responsive to certain wavelength of light to covert the refraction from positive refractive index to negative or zero refractive index based on resonance. The resonator includes a spiral or split ring pattern. The ring shape includes circle, rectangle, triangle, C-shape, S-shape, U-shape or any combination of the above.

The present invention discloses a lens set having light resonators, the lens set includes at least one transparent layer having trenches. Different sizes light resonators in the trenches are responsive to visible light with different frequencies.

The present invention discloses the first light-resonator lens which includes a transparent layer having trenches; and the first resonators are disposed in the trenches and are responsive to the first visible light frequency band.

The second light-resonator lens is stacked on the first light-resonator lens, and the second light-resonator lens has the second light-resonators which is different in size from the first light-resonators and is responsive to the second visible light frequency band. There are at least two visible light frequency bands, preferably, at least three visible light frequency bands while the third light-resonator lens is provided.

The light resonator array includes at least three sub-units, each sub-unit is configured with one resonator, and the shape of each sub-unit is hexagon, triangle, rhombus, or rectangle shape.

The present invention discloses a light resonator lens including the first light resonator array having the first light resonators; the first insulating layer is formed on the first light resonator array. The second light resonator array with the second light resonator, is disposed on the first insulating layer, wherein the size of the first light resonator is different from that of the second light resonator, and they are respectively responsive to different visible light frequencies (or wavelengths). A second insulating layer is formed on the second light resonator array, and the third light resonator array is disposed on the second insulating layer. The unit includes at least three sub-units, each of which is hexagonal, triangular, rhombus or rectangular in shape.

A lens includes a transparent substrate; the first light resonator and the second light resonator are configurated on the transparent substrate with different size to respectively responsive to the different visible light frequencies; wherein the unit is composed of at least three sub-units, the shape of each sub-unit is hexagon, triangle, rhombus or rectangle shape, wherein each sub-unit is configured with the first light resonator, the second light resonator or the third light resonator, which is arranged on the transparent substrate.

The present invention discloses resonator lens includes a resonator array composed of a plurality of units, wherein the unit includes at least three sub-units, wherein each sub-units is configured with a resonator; the three sub-units are formed with different sizes and configurated to response to different visible light frequencies.

The present invention discloses a lens including the first resonator array and the second resonator array, each array includes a plurality of units, wherein the first resonator array and the second resonator array are respectively located on different layers, The unit is composed of at least three sub-units, each sub-unit is configured with a resonator; the first resonator array and the second resonator array have different resonator sizes and respectively respond to different visible light frequencies. Each sub-unit shape is hexagon, triangle, rhombus or rectangle.

The lens includes at least one transparent layer having trenches or grooves; a plurality of light resonators with different sizes is formed in the trenches and is responsive to visible light with different frequency; the visible light frequencies includes at least two different visible light frequencies.

The first lens includes a transparent layer having a plurality of trenched or grooves; and the first light resonators are disposed in the trenches and is responsive to the first visible light frequency band; another lens is stacked on the first lens, the second lens has the second light resonators, the size of which is different from the first light resonators, and responds to the second visible light frequency band. The unit includes at least three sub-units, and the shape of each sub-unit is hexagon, a triangle, a rhombus or a rectangle.

The lens includes the first light resonator array having the first light resonator arranged on the first layer; the second light resonator array having the second light resonator arranged on the second layer. The second layer is located on the first layer; wherein the size of the first light resonator is different from that of the second light resonator, and respectively respond to different bands of the visible light frequencies. It further includes the third light resonator array, which is arranged on the third layer; the third layer is located on the second layer. The unit of the light resonance lens includes at least three sub-units, and the shape of each sub-unit is hexagon, triangle, rhombus or rectangle.

The lens includes the first light resonator and the second light resonator, both are arranged on a transparent substrate; the size of the first light resonator is different from that of the second light resonator, and respectively respond to different visible light frequencies. The unit of the light resonator includes at least three sub-units, the shape of each sub-unit is hexagon, triangle, rhombus or rectangle, each sub-unit is configured one resonator, preferably, the third light resonator is provided on the transparent substrate.

The resonance lens includes a resonator array composed of a plurality of units, each unit is composed of at least three sub-units, each sub-units is configured with a resonator. The resonators in the sub-units have different sizes and respond to different bands of visible light frequencies.

The optical lens includes the first resonator array and the second resonator array, each is composed of a plurality of units, the first resonator array and the second resonator array are respectively located on different layers. The unit includes at least three sub-units, each of the sub-units is configured with a resonator; the resonator sizes of the first resonator array and the second resonator array are different, and respectively respond to different visible light frequencies. The third resonator array is included for an alternative embodiment. The shape of each sub-units is hexagon, triangle, rhombus or rectangle.

### BRIEF DESCRIPTION OF THE DRAWINGS

FIG. 1 shows a lens set according to an embodiment of the present invention.

FIG. 2 shows the refraction of materials with positive refractive index and zero refractive index.

FIG. 3 shows a schematic diagram of the resonator of the present invention.

FIG. 4 shows a schematic diagram of the resonator of the present invention.

FIG. 5 shows a schematic diagram of the stacking array of the present invention.

FIG. 6 shows a schematic diagram of the resonator of the present invention.

FIG. 7 shows a schematic diagram of uniform field of the present invention.

FIG. 8 shows a schematic diagram of the image sensor of the present invention.

FIG. 9 is a cross section view showing a resonator lens of the present invention.

FIG. 10 is a cross section view showing the process of forming the resonator lens of the present invention.

FIG. 11 is a cross section view showing the process of forming the resonator lens of the present invention.

FIG. 12 shows a schematic diagram of the resonance frequencies of the present invention.

FIG. 13 is a cross section view showing a resonator lens of the present invention.

FIG. 14 is a cross section view showing a resonator lens of the present invention.

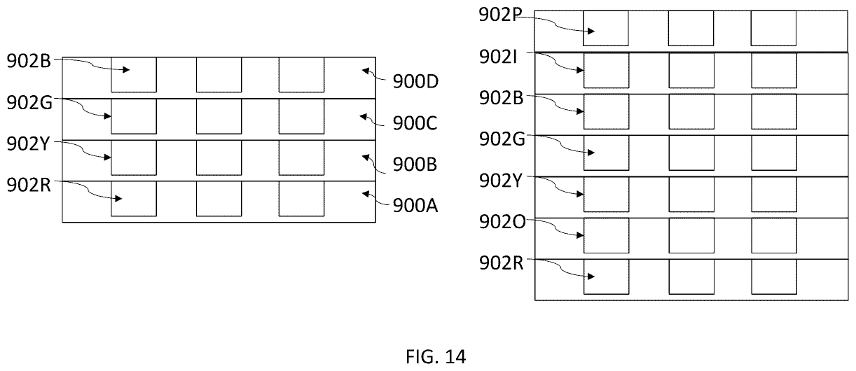

FIG. 15 is a cross section view showing a resonator lens of the present invention.

FIG. 16 is a top view showing a resonator unit of the present invention.

FIG. 17 illustrates an example configuration of a pair of prisms provided on an optical path between a lens and an image sensor.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

Diopter (D), symbol dpt, is a unit of measurement with dimension of reciprocal length, equivalent to one reciprocal meter, 1 dpt=1 m⁻¹. The SI unit is the reverse meter (m⁻¹). It is normally used to express the optical power (P) of a lens or curved mirror, which is a physical quantity equal to the reciprocal of the focal length (f), expressed in meters, that is, P=1/f. For example, a 3-dioptre lens brings parallel rays of light to focus at ⅓ meter.

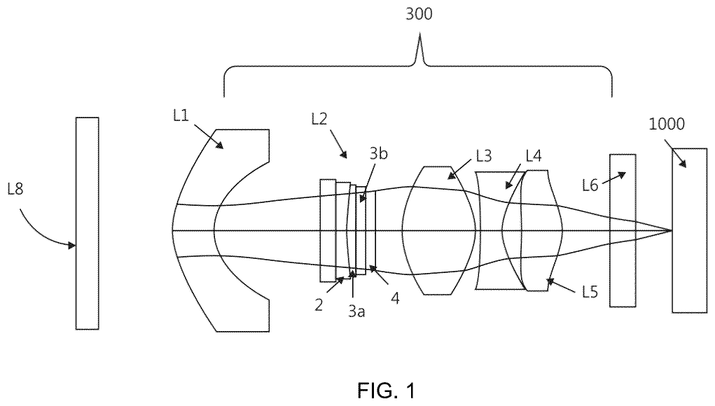

Referring to FIG. 1, the present invention provides an optical lens set 300, which includes a plurality of lenses arranged along the optical axis from the object side to the image side. The first lens L1 has negative refractive power, and the convex surface of the first lens L1 faces the object side. The second lens L2 is an electronically controlled zoom lens or a non-variable lens. If it is an electronically controlled zoom lens, the curvature radius of the second lens L2 is adjustable to change the effective focal length. The third lens L3 has positive refractive power, and the surfaces of the third lens 13 facing the object side and the image side are both convex surfaces. The fourth lens L4 has negative refractive power, and the convex surface of the fourth lens 14 faces the image side. The fifth lens L5 has positive refractive power, the convex surface of the fifth lens L5 faces the image side.

In one embodiment, the second lens L2 includes a first cover lens 2, a zoom lens and a second cover lens 4 in order from the object side to the image side along the optical axis. The first cover lens 2 and the second cover lens 4 respectively cover both sides of the zoom lens along the optical axis direction. The zoom lens is made of a first material layer 3a and a second material layer 3b. The curvature of the zoom lens is changed according to the voltage applied to the zoom lens, thereby achieving the zooming effect. This zoom lens can be a liquid lens, which can be liquid filling, liquid crystal, or electrowetting; electrowetting refers to applying voltage to cause the interface of two incompatible liquids to deform; liquid filling is to change the volume of the liquid between the two films to deform the lens; Liquid crystals basically change the refractive index of the interface material by voltage. Each lens must be molded from plastic, glass, quartz and other materials. The preferred method is to use plastic, which can reduce material costs compared to glass. The variable curvature lens overcomes the deterioration of image quality when taking close-up shots with traditional fixed-focus lenses.

The plane lens L6 can be an infrared filter or a protective glass piece. The plane lens L6 has an infinite focal length and is arranged behind the fifth lens L5 along the optical axis. The lens set 300 usually corresponds to the image sensing element 1000, which is disposed at the imaging surface. If the first lens L1, the second lens L2, the third lens L3, the fourth lens L4 and the fifth lens L5 have aspherical optical surfaces, the surface curves are defined according to the Aspherical Surface Formula.

In another embodiment, the optical lens assembly includes an aperture (not shown) disposed between the first lens L1 and the second lens L2; the infrared filter L6 is disposed between the fifth lens L5 and the imaging surfaces, they are usually made of flat optical materials.

Smartphones are basically starting to feature 6P lenses or 7P lenses. Each mobile phone camera is composed of lens set, focus motor, infrared filter and other components. The lens set is composed of multiple lenses. When light passes through, the multiple lenses correct the path of the light. Theoretically, the more lenses there are, the more realistic the image will be. The advantage of a multi-lens lens set is to have the ability to gather light, which can enhance the resolution of the lens. Previous technology required the use of multiple lenses to improve light gathering capabilities and enhance resolution. The main reason is that the front lens used in the previous technology is a positive refractive index medium.

Light is composed of electric and magnetic fields. The interaction between traditional lenses (or other natural materials) and light depends majorly on the interaction with electric fields. The magnetic interaction in traditional lens materials is basically zero, which leads to common optical constraints, such as diffraction limitations. Negative refractive index media may overcome this limitation. In 1995, Guerra produced a diffraction grating in silicon with 50 nm lines and spaces which is illuminated with diffraction-born evanescent waves from its transparent replica. Super-resolution is observed with a microscope having an incident illumination of 650 nm in air. Please refer to: Appl. Phys. Lett. 66, 3555-3557 (1995). In 2002, Guerra et al published subwavelength nano-optics for optical data storage at densities well above the diffraction limit, refers to: Japanese Journal of Applied Physics. 41 (Part 1, No. 3B): L866-L875. In the visible light band, if a structure or material exhibits magnetism at high frequencies, resulting in strong magnetic coupling. This can produce a negative index of refraction in the optical range.

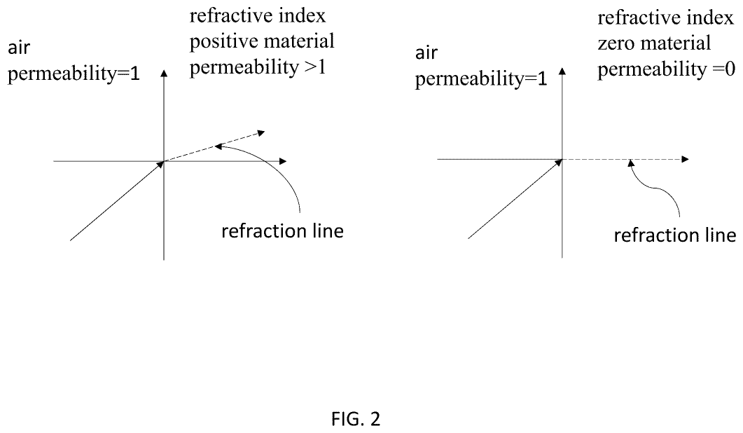

Space mapping is derived from coordinate transformation, which shows that electromagnetic fields can be manipulated, see Pendry, J. B., D. Schurig, and D. R. Smith, “Controlling electromagnetic fields,” Science, Vol. 312, 1780, 2006. The spatial transformations can be applied from optical to all frequencies. As mentioned above, the front lens in the prior art causes divergent light. Therefore, the present invention configures a light bending element, such as a lens, at the front end of the lens set to condense the divergent light (electromagnetic waves). Refer to the left side of FIG. 2. Generally, the transmission of light from air into materials follows the right-hand rule, and its refractive index is positive, thus causing light (electromagnetic waves) to diverge. If the medium's permittivity (ε=ε₀εᵣ) or permeability (μ=μ₀μᵣ) is zero (or approaches zero), its refractive index approaches 0, which is a zero-refractive index material. If the medium's permittivity or permeability is negative, it refers to negative refractive index material. The refractive index of the negative-index material for an electromagnetic wave is a negative value over some frequency range. For plane waves propagating in electromagnetic metamaterials, the electric field, magnetic field and wave vector follow a left-hand rule, the reverse of the behavior of conventional optical material. See the right side of FIG. 2. In optics, the refractive index (or refraction index) of an optical medium is a dimensionless number that gives the indication of the light bending ability of that medium. The refractive index can be seen as the factor by which the speed and the wavelength of the radiation are reduced with respect to their vacuum values. The refractive index is proportional to the root of the product of ε and μ. For most materials, the permittivity and permeability are positive values, while the permittivity of plasma is negative, and the permeability of ferrite is negative. In 2009 Plum, E et al. proposed the properties of negative refractive index materials, see Physical Review B. 79 (3): 035407.

At the interface between zero refractive index material and free space, no matter what incident angle the electromagnetic wave is incident on the zero refractive index material (or negative refractive index material), the incident light is bend to nearly parallel to the normal line of the interface. When the negative index of refraction occurs, propagation of the electromagnetic wave is reversed. Resolution below the diffraction limit becomes possible. This is known as subwavelength imaging. The light will refract in the reverse direction (negatively) at the interface between a material with negative refractive index and a material exhibiting conventional positive refractive index. Light incident on the negative refractive index material will bend to the same side as the incident beam, and for Snell's law to hold, the refraction angle should be negative. Negative refractive index or zero refractive index materials can bend the incident light to approximately parallel the normal line of the interface. The present invention takes advantage of this characteristic and arranges it on the front side of the lens assembly, which can effectively converge incident light (electromagnetic waves), thereby improving the directionality and performance of visible light. It refers to optical resonant medium or optical resonant lens. It means that the lens has resonators to bend visible light.

Referring to FIG. 1, the present invention configures a light converging lens (light resonance lens) L8 at the front end of the lens set or assembly, which can also be regarded as a part of the lens set, that is, the present invention includes the lens set 300 and the light condensing lens (light resonance lens) L8. The L8 has an effective negative refractive index or zero refractive index to improve the directionality of electromagnetic waves and eliminate the light divergence caused by traditional positive refractive index lenses. Therefore, this invention can reduce the number of lenses and achieve high-resolution and low-distortion effects, so the length the lens set be reduced. Because light is converged in parallel into the lens set, the image resolution and effect are improved even at night or darkness. In a preferred embodiment, the present invention disposes zero or negative refractive index medium at the front end of the lens set 300, it may perform the cover of the lens set or replace the original protection glass, the light bending and protection functions are integrated under the configuration.

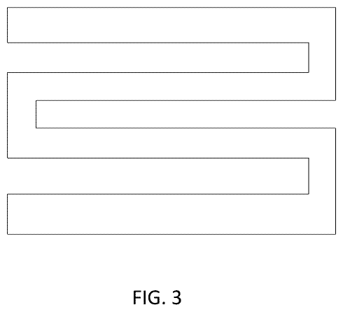

The light converging lens (light resonant lens) L8 can be understood as a combination of units. Some units are composed of permittivity media, while other units are composed of permeability media; it can also be composed entirely of the two kinds of materials. The resonant size is less than the visible light wavelengths, the composite unit may include the permittivity and the permeability medias. One or both of the negative permeability and negative permittivity media used in the resonance lens L8 medium of the present invention. Examples of unit patterns include a length of wire, a wire with a loop (or multiple loops) along its length, a coil or multiple wires with loops, other examples include resonators based on spiral patterns. In another embodiment, the surface of the optical lens L8 may have a transparent continuous S-shaped pattern, please see FIG. 3.

Hardy W N, Whitehead L A proposed that the ring resonator can be used for magnetic resonance. The sub-wavelength resonant rings are placed in opposite directions to each other with adjustable magnetic permeability. In order to generate resonance and enhance the magnetic response, capacitors can be introduced. The inductors and the capacitors work together to form a resonant circuit, and the metal ring can be regarded as the inductor. A slit or gap is formed by etching the metal ring to form the capacitor, and charges will accumulate at both ends of the capacitor. The resonant ring is analogous to the resonant circuit. Negative permittivity or/and negative permeability can be obtained by controlling the resonance of the medium. Resonance means that the material tends to vibrate at a specific frequency. The resonant circle is used to simulate the electromagnetic response of the material. The size of the resonant unit matches the wavelength of the electromagnetic wave. The magnetic flux penetrating the metal ring will induce rotating currents in the ring, thus generating its own magnetic flux to enhance the incident field. This field pattern has dipolar properties. Negative permeability is due to the action of the resonator. When an electrically small resonator array is excited by a time-varying magnetic field, the structure behaves like an equivalent medium with negative permeability in the resonance frequency band. The periodic configuration of the resonator units allows electromagnetic waves to interact as if they were homogeneous materials.

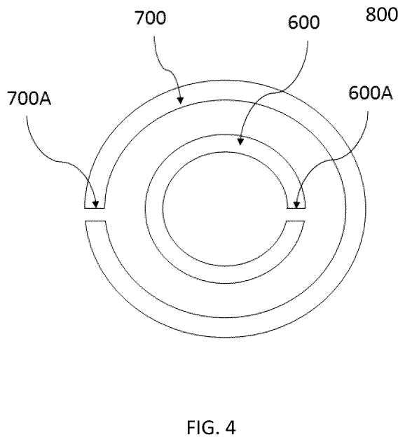

The resonant unit such as a split ring resonator interacts with electromagnetic waves. In the present invention, the size of the resonant unit needs to be resonantly matched to the wavelength of visible light. Cell sizes smaller than visible light wavelengths, for example, nested circular split ring resonators with an inner radius of about 30 to 40 nanometers which are capable of interaction in the mid-range of the visible spectrum. Resonators can be rectangular, triangular or circular rings. The medium with split ring resonator arrays produces strong magnetic coupling with the electromagnetic field, which is a characteristic that traditional materials do not have. For example, the periodic split ring resonator array produces negative permeability and other effects. Referring to FIG. 4, each individual split ring resonator 800 is composed of a pair of loops 600 and 700. The loops 600 and 700 have slits 600A and 700A at both ends. Loops 600 and 700 are made of non-magnetic metals such as copper and silver, with a small gap between the loops. The rings can be concentric or square, with gaps set as needed, and the magnetic flux penetrating the metal ring will produce a dipole pattern of electromagnetic fields in the ring.

The small gaps between the rings produces large capacitance values which lowers the resonating frequency. Hence the dimensions of the structure are small compared to the resonant wavelength. This results in low radiative losses and very high-quality factors. In one embodiment, the radius of the split ring resonator is related to the wavelength of the electromagnetic wave. The split ring resonators can be created using semiconductor micro- or nano-fabrication techniques, direct laser or electron beam lithography depending on the resolution required. For example, the terahertz band frequency, which is typically defined as 0.1 to 10 THz, is located at the end of the infrared band, just after the end of the microwave band. This corresponds to millimeter and submillimeter wavelengths between 3 mm (EHF band) and 0.03 mm (long wavelength edge of far-infrared light); for microwave radiation, the structure dimensions are of the order of millimeters.

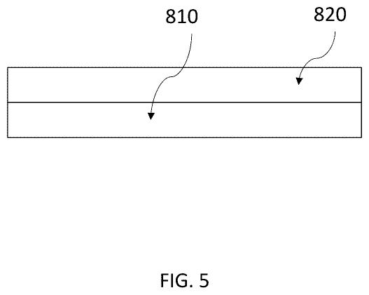

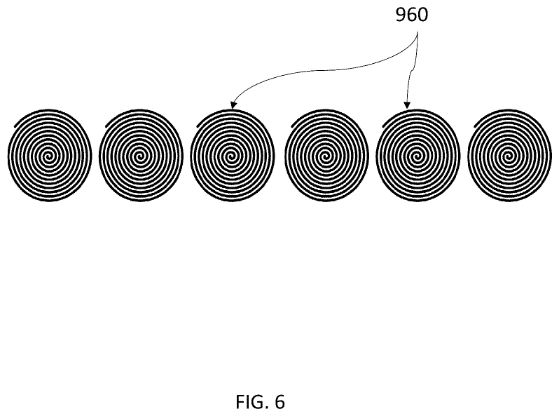

In one embodiment, the split ring resonator 800 is composed of a pair of concentric metal rings formed on the dielectric substrate, with slits 600A, 700A etched on opposite sides, see FIG. 5. It can be implemented by semiconductor photolithography processes, printed circuit processes, or electroplating processes. The material of the ring could be ITO, IZO. The main purpose of the split ring resonator is to produce negative or zero permeability medium (material). When the split ring resonator array is excited by a time-varying magnetic field, the structure behaves like an equivalent permeability medium with negative values. Split ring resonators can be used to increase the transmission distance of near-field waves. The split ring resonators exhibit resonant electric response in addition to resonant magnetic response. The response is averaged over the composite structure when it combined with an array of wires, which results in effective values, including the refractive index. Referring to FIG. 6, the split ring resonator array layer 810 and the wire array layer 820 can be fabricated on different layers and similar multiple layers are stacked in sequence, depending on the needs and performance. This is a two-dimensional array; three-dimensional array can also be fabricated.

According to above, a U-shaped resonator can also be used. A nanoscale resonator unit has three small metal rods that are physically connected and are configured in a U-shape. The gap at the open end of the U-shape acts as a nanocapacitor. This forms an optical nano-LC resonator that generates local electric and magnetic fields when externally excited. In another embodiment, C-shaped or S-shaped resonators may also be used. Resonators can be stacked in one or more layers; it should be noted that none of the resonators are connected to a power source.

Traditional positive refractive index medias casus electromagnetic waves divergence. In order to increase resolution and reduce deformation, the solution of the traditional method is to increase the number of lenses. However, these are still all positive refractive index materials, therefore, many lenses are required to correct the light offset and dispersion lens by lens. Due to the chromatic divergence phenomenon, the traditional designs cannot meet the requirements of directivity, size reduction or bandwidth increase at the same time. The present invention uses negative permeability (or/and negative permittivity) composite materials to improve lens performance. The optical resonance medium or optical resonance lens L8 is arranged in front of the lens set to collect parallel light. Based on material spatial mapping, the electromagnetic field converges in the near field. Under the phenomenon, the electromagnetic waves are bent and converged by the optical resonance lens L8 to generate parallel waves. Therefore, the present invention has a better light convergence effect.

In another embodiment, the resonator array can be configured on one side of the protective lens, and an infrared filter or a blue ray filter can be coated on the other side to further reduce the number of lenses. The resonances of the optical lens L8 is excited by visible lights, and the resonance frequency is related to the light wavelength. The purpose of the resonance is to generate a negative permeability medium. When the resonance is excited through the magnetic field, the structure behaves like the medium with negative or zero permeability. The optical lens L8 can be used to converge visible light, the light entering the lens set is parallel light instead of divergent light, thereby reducing gradually the number of correcting lenses.

The above lens L8 includes a plurality of resonators, and the resonators include a spiral coil 960. Refer to FIG. 6. The spiral coil 960 is used as a resonator and is arranged in front of the lens set. For example, at least one helical coil 960 is disposed outside the protective lens. The resonator is excited by visible light. In addition, the above-mentioned split ring resonator array may replace the spiral coil 960 array in another embodiment, depending on the requirements.

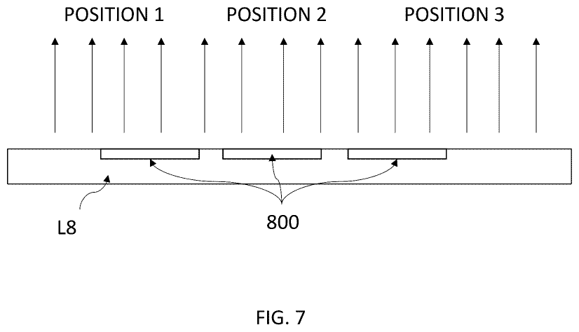

Referring to FIG. 7, based on the split ring 800 or the spiral coil 960 acting as the resonator, the visible light distribution through the protective lens is uniformed (indicated by the upward arrow in the figure), therefore, the electromagnetic wave density at the position 1, the position 2, the position 3 are all identical. Compared with the electromagnetic wave divergence caused by traditional media, the present invention has better effects.

Based on the resonance lens L8 is configurated outside of the lens set (it may be considered as a part of the lens set), the resonator array excites due to the electromagnetic field of visible light, thereby changing the refractive index of the transmission medium, forming a zero or negative refractive index medium which enhances the electromagnetic field of the system to overcome limitations, and increase the transmission energy and efficiency. Typically, the visible light determines the power transfer level, efficiency, and overall performance of the system.

In one embodiment, the resonator array is fabricated on a glass substrate, for example, repeating periodic resonators are provided on the glass, and a multi-layer resonator array can be fabricated through lamination to produce a two-dimensional or three-dimensional array. In addition to the glass, other material could be used to replace the glass as the substrate, the alternative material includes, but not limited to, plastic, quartz, and sapphire. The resonator may include part or all of straight lines, circles, squares, rectangles, triangles, spirals. In some cases, the patterns may have the gap.

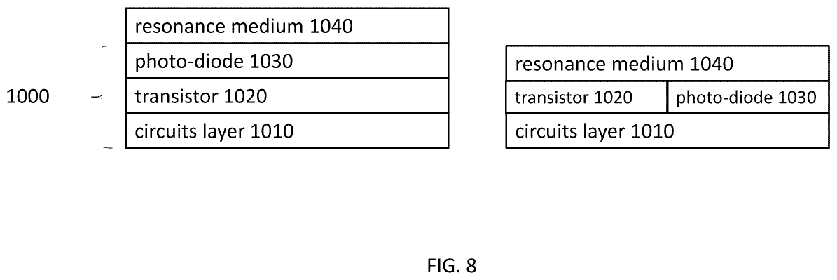

In another embodiment, referring to FIG. 8, the light resonance (meta) lens 1040 is disposed before or on an image sensor 1000 to increase the number of photons received by the sensor 1000, thereby increasing the performance. The image sensor 1000 includes CCD and CMOS sensor. In one embodiment, the image sensor 1000 includes a single-layer or stacked photodetection structure (photo-diode). Basically, the stacked photodetection structure increases the signal to twice the past, thereby improving the dynamic range and reducing noise. The traditional single-layer structure generally places the photodiode 1030 and the pixel transistor 1020 on the same layer respectively above the circuit layer 1010. In the stacked structure, the photodiode layer 1030 is stacked on the transistor layer 1020, and the transistor layer 1020 is stacked on the circuit layer 1010. This structure can optimize each single layer to increase saturation signal or improve the charge accumulation performance and enhance the photosensitivity. Since the pixel transistor is located on a separate layer, the size of the amplifier transistor will be not the major issue. The light resonance lens 1040 is formed over the photodiode layer 1030 to improve the sensing signal and it is benefit for sensing at dark environment. The photodiode layer 1030 is located at the focal length of the visible light resonant medium or lens 1040.

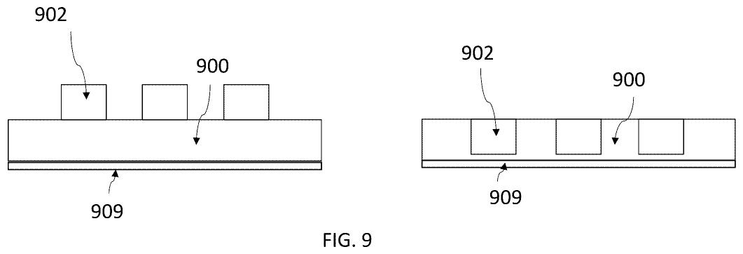

Referring to FIG. 9, the light resonant lens 800 includes a plurality of nano-resonators 902 formed on a transparent substrate 900. In another embodiment, the nano-resonators 902 are formed in the transparent substrate 900, for example, they are formed in a trench of the transparent substrate 900. The nano-resonators 902 can be conductive pillars, forming an antenna-based resonator which is capable of responsive to the wavelength of incident light. The material of the nano-resonator 902 includes silicon, such as polycrystalline silicon, single crystal silicon or amorphous silicon, which can be doped or undoped silicon; the material of the nano-resonator 902 can be a metal compound, such as titanium dioxide, gallium nitride. An alternative embodiment, the nano-resonator 902 includes metal, such as silver, gold, copper, aluminum, tungsten or the alloys of thereof. The nano-resonator 902 material can also be silicon carbide, graphene, carbon nanotubes. The material of the transparent substrate 900 may be plastic, quartz, glass (silicon dioxide), etc. A capacitance is formed between the conductive pillars and the LC oscillation structure is formed. Secondly, the transparent conductive layer 909 is optionally coated on the bottom side of the transparent substrate 900 in the manner of whole surface or in the form of grid. The conductive grid layer 909 is aligned with each resonator 902 to form a capacitive structure with the resonator 902, that is, the resonator 902/transparent substrate 900/conductive layer 909. The conductive pillars and the capacitor structure constitute an LC oscillation structure. The transparent conductive layer 909 may include ITO, ZnO, graphene, carbon nanotubes, etc.

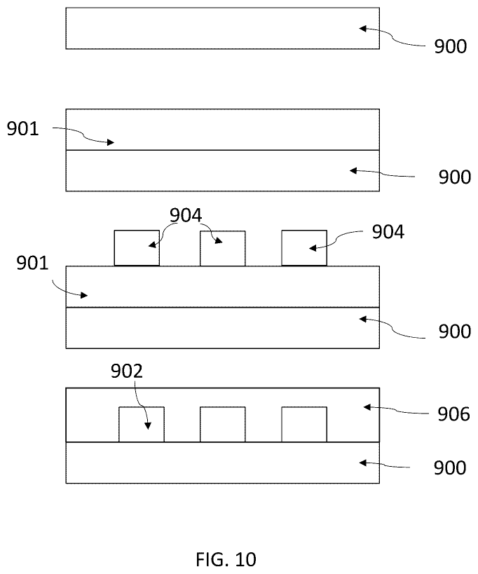

FIG. 10 shows the process of forming the light resonance lens L8. First, a transparent substrate 900 is prepared, a conductive layer 901 is coated on the transparent substrate 900, and then a photoresist is coated on the conductive layer 901. The photoresist is formed by a photolithography process. The photoresist pattern 904 acts as an etching mask for etching the conductive layer 901 by wet or dry etching processes, such as plasma etching methods, to form the nano-resonator 902 patterns on the transparent substrate 900. The parameters of the lithography process can be controlled, and the size and spacing of the resonator 902 can be controlled as well. The lithography source can be ultraviolet, deep ultraviolet, electron beam, etc. An insulating layer 906 is formed to cover the resonator 902 and the transparent substrate 900. The material of the insulating layer 906 can be silicon dioxide, silicon nitride, silicon oxynitride, glass (such as BPSG, PSG, TEOS), etc. Each insulating layer above or following embodiments is preferably made of substantially transparent material.

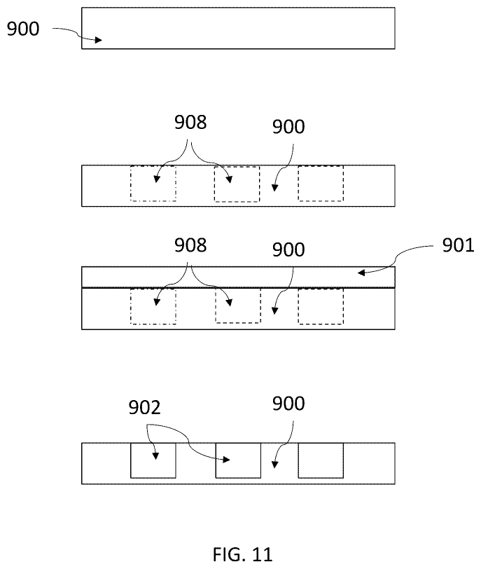

In another embodiment, as shown in FIG. 11, trenches 908 are etched in the transparent substrate 900. The photoresist is coated and the photoresist pattern is subsequently formed by photolithography processes. The photoresist pattern is then used to act as the etching mask for the wet or dry etching to etch the transparent substrate 900 to form a plurality of trenches 908. The conductive layer 902 is coated on the transparent substrate 900 and refilled into the plurality of trenches 908. Subsequently, the conductive layer 901 is planarized to a desired thickness through a planarization process. Therefore, the nano-resonator 902 is formed in the transparent substrate 900. The mask parameters of the lithography process can be controlled, and the size and spacing of the resonator 902 can be controlled as well. The lithography source can be ultraviolet, deep ultraviolet, electron beam, etc. The overall thickness of the light resonance lens produced in this embodiment is very thin. The transparent conductive layer 909 in FIG. 9 can be implemented in any step of these embodiments.

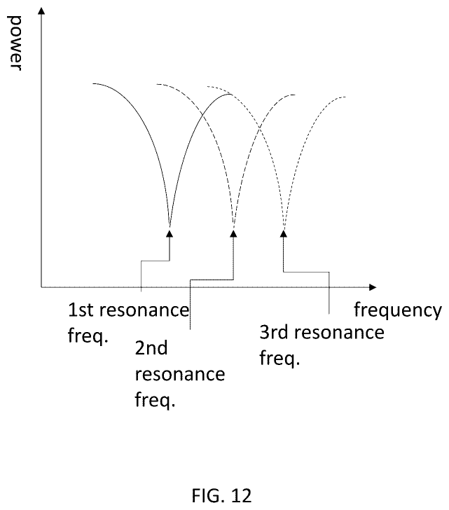

The size of the resonator 902 is related to the resonant frequency, that is, it is dependent on the wavelength of light, and the resonant frequencies generated by light of a specific wavelength are different. In order for the visible light spectrum to excite the resonates appropriately, the resonators have to be responsive to the resonant frequencies. Refer to FIG. 12, which illustrates the transmission power curve within specific wavelength ranges, it shows that the first, the second, and the third wavelengths are respectively responsive to the first, the second, and the third resonant frequency bands. There will be some overlap between the three curves, there is no need to form all resonators corresponding to each color.

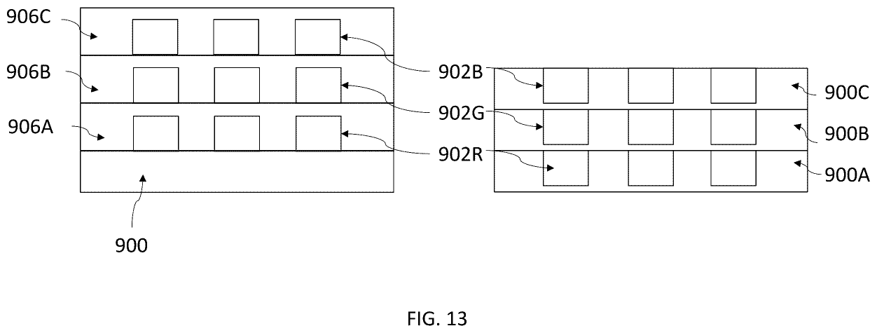

FIG. 13 shows the formation of a plurality of nano-resonators of different sizes based on FIG. 9 to facilitate response to wavelengths in different bands. For example, the first resonator array 902R is formed on the first insulating layer 900A, the second resonator array 902G is formed on the second insulating layer 900B, and the second insulating layer 900B is located on the first insulating layer 900A. The third resonator array 902B is formed on the third insulating layer 900C, and the third insulating layer 900C is located on the second insulating layer 900B. This embodiment is called an embedded type because the resonator is fabricated in the trench of the insulating layer, and the positions of the resonators in the layers can be interchanged. Resonators between different layers can be aligned or misaligned. In the embodiment, each insulating layer is preferably made of substantially transparent material.

Although the first resonator array 902R, the second resonator array 902G, and the third resonator array 902B only show three resonators for each array, since the substrate or the insulating layer is only a small part of the actual substrate. Therefore, millions of resonators can be fabricated across the entire insulating layer or substrate. After the formation of the resonators, the wafer or the substrate is then cut according to the required size. This makes it easier to produce lenses with consistent resonator pattern density. Therefore, the periodicity resonator pattern is design based on the rectangular or circular wafer substrate rather than the symmetry of the single circle lens.

Similarly, in another embodiment, the first resonator array 902R is formed on the first insulating layer 906A, the second resonator array 902G is formed on the second insulating layer 906B, and the second insulating layer 906B is located on the first insulating layer 906A. The third resonator array 902B is formed on the third insulating layer 906C, and the third resonant insulating layer 906C is located on the second insulating layer 906B. This embodiment is called stacked structure because the resonator is fabricated on the corresponding insulating layer. In the same way, the positions of the resonators in each layer can be inter-changed, and the resonators between each layer can be aligned or misaligned.

The visible spectrum (380-750 nm) can be seen by the human eye, 380-750 nm corresponds to the frequency of 790-400 MHz (tera hertz, referred to as THz). For the human eye, the most sensitive wavelength is 555 nm, which corresponds to the frequency of 540 MHz, it belongs to the green light band. The blue light wavelength is between 450-495 nm, the wavelengths of the green light, the yellow and the red light are respectively 495-570 nm, 570-590 nm and 620-750 nm. In one embodiment, the dimension of the blue light resonator is smaller than the dimension of the green light resonator. The dimension of the green light resonator is smaller than the dimension of the yellow light resonator, and the dimension of the yellow light resonator is smaller than the dimension of the red-light resonator.

Based on the architecture of FIG. 13, please refer to another embodiment shown in Figure. Under the embedded architecture in FIG. 13, four to seven layers of different sizes resonator arrays can be fabricated to be respectively responsive to, for example, red, yellow, green, and blue wavelength lights. For example, the fourth resonator array 902Y is formed between the first resonator array 902R and the second resonator array 902G. In fact, the resonators can be located in any layer. In terms of seven layers, it further includes the fifth resonator array 9020, the sixth resonator array 9021, and the seventh resonator array 902P to locate the red, the orange, the yellow, the green, the blue, the indigo, and purple lights resonators. In the same way, the method of this embodiment can also be applied to the stacked type.

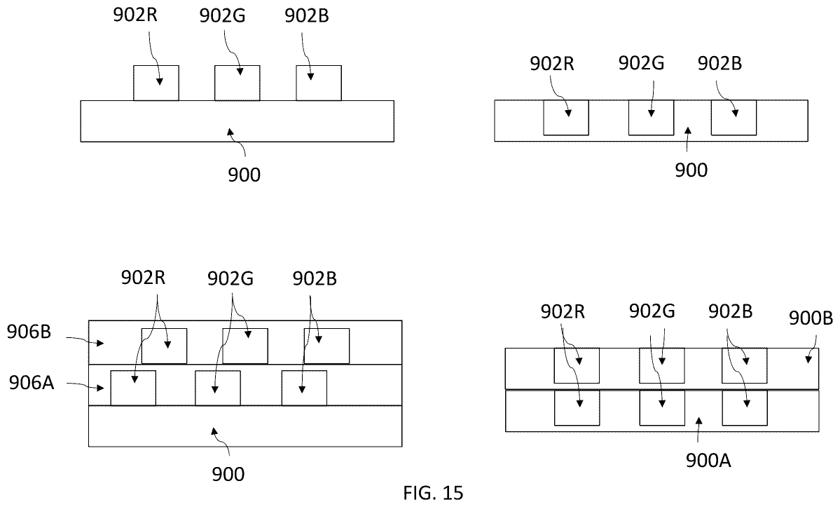

FIG. 15 shows the substrate including different size resonators formed on the same surface. Different from the aforementioned stacked architecture, in which each layer has only one size resonator to response single wavelength light, the layer shown in FIG. 15 includes at least two different size resonators to response to at least two wavelength responses, preferably, each layer includes three resonators with different sizes to be responsive to at least three wavelengths of lights. Under this architecture, multiple layers of this single-layer architecture can also be stacked to meet actual demands. Under this architecture, each layer has three resonators of different sizes. Compared with the single resonator layer, it meets the needs of low resonators number. If more resonators are needed, the multiple layers are just stacked together to meet the needs, and it is more flexible in commercial implementation. The various sizes in the single layer lower the costs, such as photomask costs. The resonators located between layers can be aligned or misaligned.

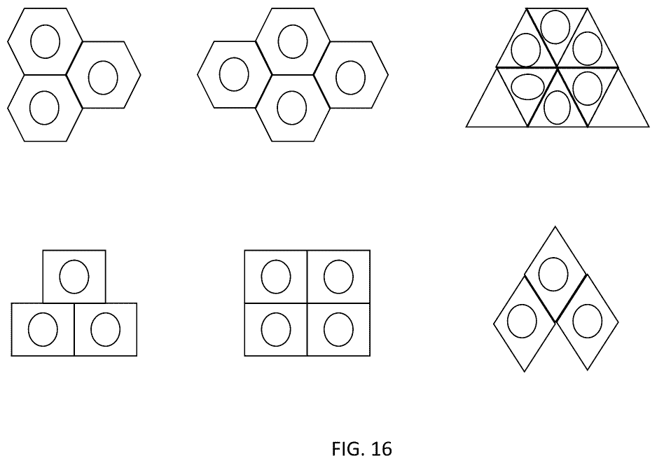

FIG. 16 shows the top view of the resonator unit. If it is a single-layer structure of the same type, the shape of the unit is a honeycomb (hexagon), triangle, rhombus or rectangle. Each sub-unit is formed with same size resonator, and the top view can be circular, elliptical, rectangular shape, etc. If it is a single-layer heterogeneous architecture, the unit is composed of three or four honeycomb (hexagonal), triangular, rhombus or rectangular units, each of which is formed with resonators of different sizes.

Preferably, the present invention may include the fourth resonator array formed in or on the fourth layer, wherein the fourth resonator array includes the fourth resonator size for being responsive to an infrared.

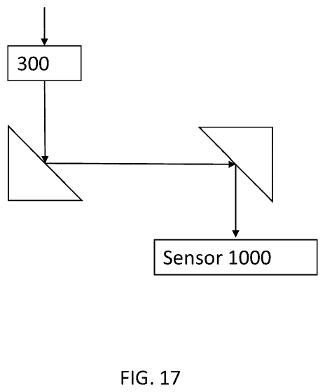

Please refer to FIG. 17, the mobile phones or the pads includes various lens sets, for example, a wide-angle lens gives a view of an extremely wide area, with the central objects appearing closer than those at the edge. A telephoto lens reduces the distance between the photographer and the subject. However, the focus length of these lens is longer than the demand of the smart phone thickness. One solution is shown in FIG. 17, a pair of prisms is introduced in the optical path between the lens 300 and the image sensor 1000 to lengthen the path. Another method is to add at least one Fresnel lens in the lens set, or replace one of the positive power lenses in the lens set 300 (refer to FIG. 1) by the Fresnel lens which reduces the amount of material required compared to a conventional lens by dividing the lens into a set of concentric annular sections. For example, the lens L1 or L3 is replaced by the Fresnel lens. The Fresnel lens has prismatic elements that use total internal reflection as well as refraction to capture more oblique light from the light source, making it more visible at greater distances. The design allows the construction of lenses of large aperture and short focal length without the mass and volume of material that would be required by conventional design. A pair of face-to-face Fresnel lenses may be used to further improve the performance of the lens set 300. The face refers to the surface has prismatic elements. Alternatively, the light resonance lens and the Fresnel lens are both configurated for the lens set.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A smart phone having an optical lens, comprising:
a lens set, said optical lens being configurated in front of said lens set; and
wherein said optical lens includes at least one transparent layer having resonators formed in or on said at least one transparent layer, wherein said resonators are formed with different sizes and responsive to different light frequencies.

2. The smart phone of claim 1, wherein said light frequencies includes at least three visible light frequencies.

3. The smart phone of claim 2, wherein said at least one transparent layer includes trenches, said resonators being formed in said trenches.

4. The smart phone of claim 3, wherein said resonators includes pillars, spirals, split rings or the combination thereof, wherein said resonators includes silicon, ITO, ZnO, graphene, carbon nanotubes, metal, alloy or the combination thereof.

5. The smart phone of claim 1, wherein said resonators includes pillars, spirals, split rings or the combination thereof.

6. The smart phone of claim 1, wherein said resonators includes silicon, ITO, ZnO, graphene, carbon nanotubes, metal, alloy or the combination thereof.

7. A smart phone having a lens set, comprising:
a first resonator array formed in or on a first layer;
a second resonator array formed in or on a second layer formed on said first layer; and
wherein a first resonator size of said first resonator array is different from a second resonator size of said second resonator array, to respectively response to lights with different frequencies.

8. The smart phone of claim 7, wherein a third resonator array formed in or on a third layer, which is formed on said second layer, wherein said third resonator array includes a third resonator size.

9. The smart phone of claim 8, wherein a fourth resonator array formed in or on a fourth layer, wherein said fourth resonator array includes a fourth resonator size for being responsive to an infrared.

10. The smart phone of claim 8, wherein said first resonator size is longer than said second resonator size, said second resonator size being longer than said third resonator size.

11. The smart phone of claim 8, wherein said first, second and third resonator arrays include pillars, spirals, split rings or the combination thereof.

12. The smart phone of claim 8, said first, second and third resonator arrays include silicon, ITO, ZnO, graphene, carbon nanotubes, metal, alloy or the combination thereof.

13. The smart phone of claim 7, wherein said first resonator arrays, said second resonator arrays are configurated in front of said lens set, an image sensor or the combination thereof.

14. The smart phone of claim 7, further comprising a Fresnel lens formed in or in front of said lens set.

15. A smart phone having a lens set, comprising:
first resonator pillars formed in or on a first layer;
second resonator pillars formed in or on a second layer formed on said first layer;
third resonator pillars formed in or on a third layer formed on said second layer;
wherein said first resonator pillars is longer than said second resonator pillars, said second resonator pillars being longer than said third resonator pillars to response to lights with different frequencies.

16. The smart phone of claim 15, wherein fourth resonator pillars formed in or on a fourth layer to response to an infrared or a fourth light frequency.

17. The smart phone of claim 15, wherein said first, second or third resonator pillars are replaced by spirals, split rings or the combination thereof.

18. The smart phone of claim 15, wherein said first, second and third resonator pillars include silicon, ITO, ZnO, graphene, carbon nanotubes, metal, alloy or the combination thereof.

19. The smart phone of claim 15, wherein said first resonator pillars, said second resonator pillars and said third resonator pillars are configurated in front of said lens set, an image sensor or the combination thereof.

20. The smart phone of claim 15, further comprising a Fresnel lens formed in or in front of said lens set.
